(19) United States
(12) Patent Application Publication
(10) Pub. No.: US 2012/0319502 A1
(43) Pub. Date: Dec. 20, 2012

(54) VIRTUAL SWITCH AND METHOD FOR OPERATING SAME

(75) Inventor: Peter Van Gastel, Solingen (DE)

(73) Assignee: Huf Hülsbeck & Fürst GmbH & Co. KG, Velbert (DE)

(21) Appl. No.: 13/576,202

(22) PCT Filed: Feb. 1, 2011
(86) PCT No.: PCT/EP2011/051366

§ 371 Date: Sep. 4, 2012

(30) Foreign Application Priority Data
Feb. 1, 2010 (DE) 10 2010 009 149.9
Apr. 22, 2010 (DE) 10 2010 018 164.1

(51) Int. Cl. H01H 35/00

(52) U.S. Cl. 307/116

(57) ABSTRACT

The invention relates to a method for actuating a virtual switch (50) by means of a sensor system (17.2) which detects an actuation of the switch (50), the sensor system (17.2) having at least two non-contact sensors (11, 12). The method comprises the following steps: a) starting the method, b) monitoring at least one sensor (11), starting a first timer (11.2) for a first period (11.3) if the first sensor (11) is activated (by an approaching object), d) starting a second timer (12.2) for a second period (12.3) if the second sensor (12) is activated (by an approaching object) and the first period (11.3) is not yet exceeded, and e) actuating the virtual switch (50) if at least one sensor (11, 12) is deactivated and the second period (12.3) is not yet exceeded, some of steps a) to e) proceeding simultaneously or chronologically.

### TECHNICAL FIELD

The present invention relates to a method for the actuation of a virtual switch. Such virtual switches serve the purpose of operating a moving part, such as a trunk hatch, a door, or the like in a vehicle, in particular a motor vehicle. The comfort of the vehicle should be improved by the virtual switch because it is possible to open the moving part without requiring the hands to do so. The present invention is likewise related to a device for the actuation of the virtual switch.

### BACKGROUND

The publication DE 10 2009 017 404 A1 discloses a virtual switch automatically open and/or close a moving part in a vehicle, for example. The publication EP 2 098 670 A1 also discloses a vehicle having a virtual switch for a moving part.

In the case of these virtual switches, the fundamental problem exists that they initiate a switch signal and therefore an actuation even when an undesired object such as a cat or a ball, for example, is detected by means of measurement by the virtual switch.

As such, the problem addressed by the present invention is that of providing a method and a device which enable increased operational reliability of the virtual switch. In this case, error signals from the virtual switch should particularly be prevented.

### BRIEF SUMMARY

In the context of this invention, the term “moving part” is understood to mean each door, side door, or sliding door, hatch, or the like of a vehicle, having at least one closed state and one opened state, wherein the closed state is achieved by means of an electrical and/or mechanical lock in order to prevent an undesired or unauthorized opening. The lock can particularly work together this moving part with a central locking system, preferably as an “active-” and or “passive keyless go system” of the vehicle. The vehicle itself can be a motor vehicle.

The present invention concerns a method for the actuation of a virtual switch, having a sensor system which detects an actuation of the switch, wherein the sensor system has at least two touchless sensors. These touchless sensors can be designed, as is suitable to their purpose, as proximity sensors, particularly capacitive sensors. In this case, in the first solution of the method according to the invention, the following steps are carried out:
a) initiation of the method,
b) monitoring of at least one first sensor,
c) starting of a first timer for a first time span if the first sensor is activated, particularly by means of an approaching object (e.g., a person),
d) starting of a second timer for a second time span if the second sensor is activated, particularly by the approaching object, wherein the first time span is not yet exceeded,
e) actuation of the virtual switch if at least one sensor is deactivated and the second time span is not yet exceeded,
and wherein particularly the steps a) to e) are carried out partially at the same time or in a chronological sequence.

In the monitoring of the sensor circuitry, it is permanently checked whether an object (e.g., a person, driver of the vehicle) has approached the corresponding sensor or not. If an object has approached the sensor, in the context of this invention the sensor is considered to be activated. Otherwise, if the sensor cannot detect an object in its detection area, in the context of this invention the sensor is considered to be deactivated. A deactivation of the sensor also occurs if the measurement value of the sensor in question is below a defined threshold. In this case, the approaching of the object is still sufficient, for example, to activate the sensor.

In a second independent solution of the method according to the invention, the method according to the invention is started once again (re-started) if all sensors are deactivated. In this case, first the first sensor and then the second sensor can be deactivated. The second sensor can also likewise be deactivated first, and then the first sensor. Both sensors can also be deactivated at the same time in order to re-start the method according to the invention. As such, this solution has the prerequisite that the sensors of the sensor system are both deactivated before step a), particularly the initiation of the method, is begun. However, this sets as a prerequisite that no object is positioned in the detection area of the sensors. A further timer can optionally be included, which runs for a prespecified time span, e.g., between 0.5 and 2 min. After the timer runs out, the method according to the invention is then started at step a), even if a sensor should still be activated.

A calibration process can also likewise be carried out prior to the first initiation of the method according to the invention in order to calibrate the sensor system with the sensors. This calibration method is therefore initiated when the virtual switch and/or the sensor system thereof is/are switched for the first time. Only once the calibration method has been properly carried out does the method according to the invention begin at step a), and/or when all sensors are deactivated. The calibration method serves the purpose of adjusting the sensor system to current measuring conditions. These change as a result of weather conditions and the measurement environment (e.g., obstacles), for example, as well as possibly as a result of dirt on the vehicle. A calibration sensor can be included for the purpose of the calibration method, by means of which the actual measurement sensors are calibrated. Likewise, prespecified thresholds can also be utilized for the calibration of the individual sensors.

In the method according to the invention, the first sensor can also first be deactivated after step d) and before the start of step e), wherein in this case the second sensor is deactivated. It can likewise be contemplated that the sequence of the deactivation of both sensors is switched, such that the second sensor is first deactivated after step d) and then the first sensor is deactivated in step e). A pattern of movement of the object in the detection area of the sensors can be clearly and unambiguously detected by means of this prespecified sequence. The possibility also optionally exists of training the virtual switch as part of a “learning process” for a desired pattern of movement. In this case, it is only necessary to inform the virtual switch that the following measured pattern of movement serves as a comparison process for later actuations.

The method step e) of the method according to the invention can be modified as the following step e′):
e′) actuation of the virtual switch if at least two sensors are deactivated and the second time span is not yet exceeded.

As such, the step e′) sets as a prerequisite that the detected object has been removed from the detection area of at least two sensors, whereby the virtual switch is actuated if the second time span is not yet exceeded. Because the sequence of the activation of the corresponding sensors can also be prespecified, a precise pattern of movement can be defined wherein only the virtual switch is actuated. By the use of a further sensor, the measurement precision of the virtual switch can also be increased.

In the method according to the invention, the first time span and/or the second time span can be prespecified for both times. As already noted, the timers are started by their respective sensors as soon as the same have been activated by an approaching object. In order to prevent an arbitrary activation of the virtual switch to the greatest extent possible, the time span should be between between 50 ms and 0.9 s. The present time spans must be selected in such a manner that the actuation of the virtual switch proceeds as with a foot switch. Such a switch is typically briefly tilted by the foot and then immediately let go again, wherein the foot initially approaches the switch and is then removed. In contrast, the virtual switch should not be actuated if, for example, a person activates the sensors in the detection area while cleaning the vehicle or scraping away ice, for example. In addition, a ball rolling past or a cat passing by through the detection area does not therefore lead to an actuation of the switch. The sensors advantageously measure the approach of a person to the vehicle, the tipping movement of the foot on the virtual switch, and the subsequent removal thereof, whereby the virtual switch initiates an actuation signal in order to automatically open and/or close the moving part, particularly a door or hatch or the like in the vehicle.

However, in order to fundamentally prevent an undesired opening of the moving part in the vehicle, even if the correct pattern of movement has been executed, an authentication request can be initiated by means of a mobile ID transmitter no later than after step b), in order to unlock an access-control or security system. In addition, it can also be required than an authentication request is first carried out by means of the mobile ID transmitter before the sensor system of the virtual switch is switched on. This authentication request by means of the mobile ID transmitter can also first take place following a successful actuation of the virtual switch if the time available is still sufficient to open or to close the moving part. In any case, the virtual switch likewise is suitable for detecting an approach of the driver to the vehicle by means of measurement, in order to then initiate the authentication request by means of the mobile ID transmitter very early. If the virtual switch with its sensor system is however not utilized to initiate the authentication request, then an additional proximity sensor is required to take over this step.

In order to reliably prevent malfunctions of the virtual switch, it can be contemplated that the method according to the invention only starts when the vehicle is at a speed below 3 km/h and/or if the vehicle is stationary. Likewise, all sensors of the sensor system can initially be deactivated before the method starts for the first time. It is optionally possible that the method does not start if an ID transmitter is detected in the vehicle interior. In this case, it does not matter whether the vehicle is stationary and/or whether the access control system, the central locking system, or the like is switched on or off. In addition, by means of the temporary cessation of the method according to the invention, it is also possible to save electrical energy. This is particularly important if the vehicle has already been parked for a long time.

In addition, in the method according to the invention, a prespecified pattern of movement can be required for the actuation of the virtual switch, wherein the movement pattern is stored in the method itself by the sequence of the deactivation of the sensors according to step e) and/or e′) and the time spans for the timer. As such, it is possible in a simple manner to individually realize a concrete movement pattern for the actuation of the virtual switch by means of the method according to the invention. In this way, the method can also be adapted to different persons in a simple manner, wherein the same actuate such a virtual switch individually. Despite this, the functional reliability of the method does not suffer, because other executed movement patterns are recognized by the virtual switch as maloperation, and no actuation occurs as a result.

The spatial arrangement of the sensors can likewise be relevant for the detection, by means of measurement, of the movement pattern, wherein it is not prespecified as part of the invention whether the first sensor, for example, is arranged above or next to the second sensor, or not.

As has already been noted, the present invention also relates to a device for the actuation of a virtual switch. In this case, the virtual switch has a sensor system which detects an actuation of the virtual switch, wherein the sensor system has at least two touchless sensors. The virtual switch likewise has a control device which has at least one first timer and one storage device for a first time span, wherein the control device monitors the sensors by means of measurement. In the case of this device, the method according to the invention for the operation of the device is stored and/or saved in the control device.

The touchless sensors can be capacitive sensors or ultrasound sensors. Other proximity sensors can likewise also be used. Capacitive sensors are advantageously used, because these can be arranged securely and in a protected manner behind a panel, and do not need to be in direct contact with the environment of the vehicle.

Features and details which are described in the context of the method according to the invention naturally apply as well to the context of the device according to the invention, and vice-versa.

### BRIEF DESCRIPTION OF THE DRAWINGS

Additional measures which improve the invention are explained in greater detail below together with the description of preferred embodiments, with reference to the figures, wherein:

FIG. 1a shows an embodiment of the device according to the invention for the touchless actuation of a trunk hatch, with two sensors,

FIG. 1b shows a further embodiment of the device for the touchless actuation of a side door, with the virtual switch,

FIG. 2 shows a concrete embodiment for the actuation of the virtual switch by means of a leg and a foot of a person,

FIG. 3 shows a schematic top view of the arrangement of the sensors inside a rear bumper of a vehicle,

FIG. 4 shows a schematic side view of the arrangement of the second sensor inside the rear bumper of a vehicle, with a metallic shield,

FIG. 5 shows a schematic view of the virtual switch, with the control device in a functional connection with the sensor system and the sensors, the ID transmitter, and the trunk hatch,

FIG. 6 shows a schematic chronological diagram for the actuation of the virtual switch by a first movement pattern,

FIG. 7 shows a schematic chronological diagram for the actuation of the virtual switch by a second movement pattern,

FIG. 8 shows a schematic chronological diagram for the actuation of the virtual switch by a second movement pattern, but with a malfunctioned actuation of the virtual switch,

FIG. 9 shows a schematic chronological diagram for the actuation of the virtual switch by a second movement pattern, with a further maloperation of the virtual switch,

FIG. 10 shows a schematic flow diagram for an example of the method according to the invention, and

FIG. 11 shows a schematic flow diagram for a further example of the method according to the invention.

### DETAILED DESCRIPTION

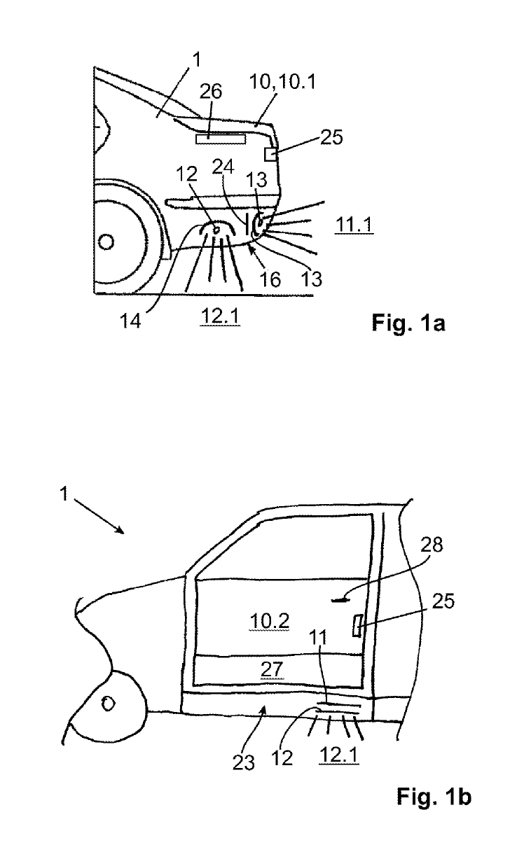

FIG. 1a shows an embodiment of the device according to the invention for the touchless actuation of a trunk hatch 10.1 as the moving part 10 of a vehicle 1, the same constituting a motor vehicle. The moving part 10 is held and secured in the closed position by an electromechanical lock 25. The virtual switch 50 has a first sensor 11 for the detection of an object 17, 17.1 in a first detection area 11.1, and a second sensor 12 for the detection of an object 17, 17.2 in a second detection area 12.1. The sensors 11 and 12 are designed as capacitive sensors 11 and 12, and are only indicated schematically in the view. The detection area 11.1 covers the horizontal area behind the rear bumper 16 of the vehicle 1. In contrast, the detection area 12.1 covers the lower area beneath the rear bumper 16. As such, a first detection area 11.1 and a second detection area 12.1 are created which are geometrically separate from each other and do not comprise a common area on the outside of the rear bumper 16, for example. Of course, the detection areas 11.1, 12.1 can also in principle overlap partially. The detection areas 11.1 and 12.1 are indicated in the figures by rays, wherein the same only indicate areas in which a change of the dielectric constant describe [sic] between the capacitive sensors 11 and 12 and the surroundings of the rear bumper 16. This change of the dielectric constant results in a change of the charge which can be stored on the electrodes of the capacitive sensors 11 and 12, which can be detected by the device. As such, the presence of an object 17, particularly the presence of a body part of a person, can be provided [sic] by the capacitive sensors 11 and 12 with minimal consumption of current.

Means 13 and 14, the same being designed in the form of metallic shields 13 and 14, extend behind the capacitive sensors 11 and 12 and enclose the same 11 and 12 in a curved or half-shell-like manner. Both of the detection areas 11.1 and 12.1 are prespecified by the shields 13 and 14, wherein an improved separation of the detection areas 11.1 and 12.1 from each other is enabled thereby. The metallic shields 13 and 14 have the same electrical potential as the corresponding capacitive sensors 11 and 12. As such, these are so-called “active shields” 13, 14. Additional ground electrodes 24 and/or ground shields 24 can be included behind these “active shields” 13, 14, wherein the detection areas 11.1, 12.1 of the capacitive sensors 11 and 12 are oriented in a direction opposite the ground shields 24 by means of said “active shields,” meaning away from the ground shields 24. The mass electrodes 24 are typically connected directly to the vehicle ground via a ground contact 19.

A similar embodiment of the device according to the invention for the touchless actuation of a side door and/or sliding door 10.1 as the moving part 10 of a vehicle 1 is illustrated in FIG. 1b. In this case, both capacitive sensors 11 and 12 are arranged in the door frame area 23 and oriented comparably to the above bumper 16 in the trunk hatch area 15. Both of the capacitive sensors 11 and 12 can also optionally be arranged in the lower area 27 of the side door 10.2, preferably below a stone guard. An approach of the object 17 to the side door 10.2 can be detected by means of the first capacitive sensor 11 or by the proximity sensor for the access control system which is typically arranged in the door handle 28. The embodiments in FIGS. 1 to 5 do not differ on the basis of the further recognition of a movement pattern for the actuation of the moving part 10 by the recognition means 11, 12. The recognition means 11, 12 and the associated means 13, 14 can also optionally have a ground shield 24.

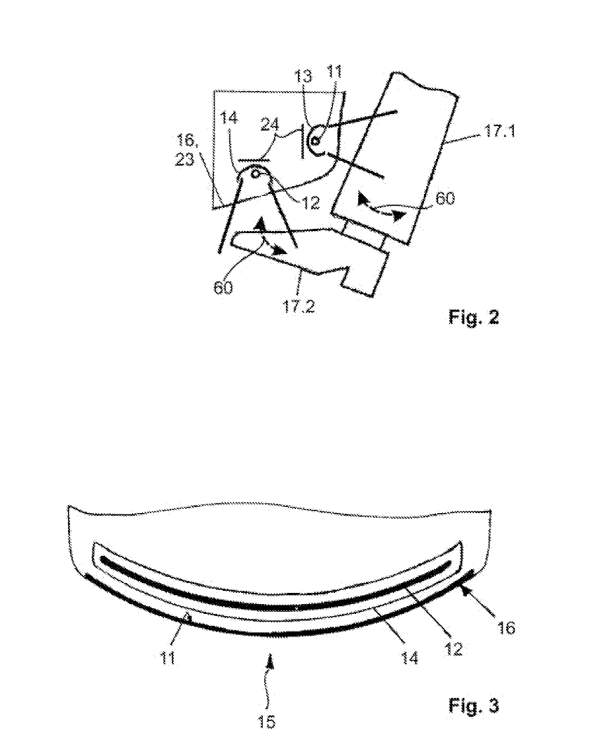

A side view of a cutaway of the rear bumper 16 and/or the lower area of the side door 10.2 is shown is FIG. 2. The capacitive sensors 11 and 12 with their respective shields 13 and 14 are inserted into the same. According to the illustration, a leg 17.1 of a person is partially shown, and projects into the first detection area 11.1, the same running horizontally. In contrast, the foot 17.2 attached to the leg 17.1 projects into the detection area 12.1, the same extending vertically beneath the rear bumper 16 and/or the door frame area 23. The person has approached the vehicle 1 in the area of the rear bumper 16 and/or the side door 10.2. As a result, the first capacity sensor 11 can detect the approach of the person by means of the penetration of the leg 17.1 into the first detection area 11.1. If the person signals the intention to actuate the moving part 10, by means of a back-and-forth movement of the foot 17.2 in the second detection area 12.1, then a prespecified movement pattern 60 of the person is created. The actuation of the trunk hatch 10.1 and/or the side door 10.2 can be initiated by the coupled detection of both the leg 17.1 and the foot 17.2. The corresponding detection areas 11.1, 12.1 can likewise be illuminated by means of an illuminating and/or display means, the same not shown. The state of the moving part 10 on the sidewalk or the street next to the vehicle can also be displayed by a lettering. During the actuation, the electromechanical lock 25 is displaced in such a manner that it releases the moving part 10, whereby it can be moved from a closed position into an open position. The opening and/or closing process itself can occur mechanically by means of the position mechanism 26 indicated in FIG. 1a, the same likewise being activated by the actuation of the virtual switch.

FIG. 3 shows a top view of the arrangement of the sensors 11 and 12 inside the rear bumper 16 of the vehicle 1. The rear bumper 16 extends over the entire trunk hatch area 15 of the vehicle, wherein the bumper 16 is shown in its entire width. In the illustration it can be seen that the sensors 11 and 12 can extend approximately over the entire width of the bumper 16. As a result, a person can approach any position over the entire hatch area 15 of the vehicle 1, and execute the movement of the leg 17.1 and the foot 17.2 described in FIG. 2.

The illustration shows the arrangement of the first capacitive sensor 11 in the vertical area of the bumper 16, whereas the second capacitive sensor 12, with the shield 14 enclosing the same, is indicated in the lower area of the bumper 16. The capacitive sensors 12 can be inserted into or laid in the bumper 16 over the width thereof as film or conductors. The capacitive sensors 11 and 12 are preferably arranged with their respective shields 13 and 14 on the interior of the bumper 16.

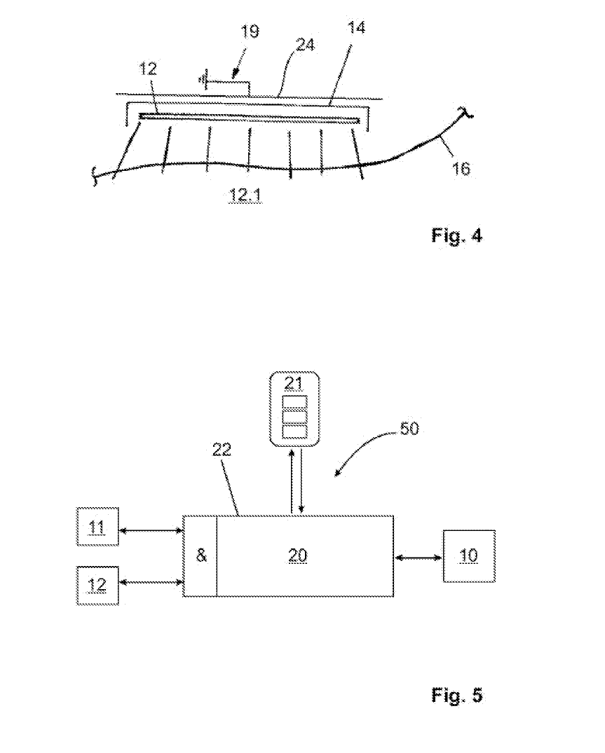

FIG. 4 shows a schematic side view of the arrangement of the second capacitive sensor 12 inside the bumper 16, which could just as well be arranged in or on the side door 10.2 of the door frame associated therewith. The capacitive sensor 12 is illustrated in cross-section and has a sheetlike profile.

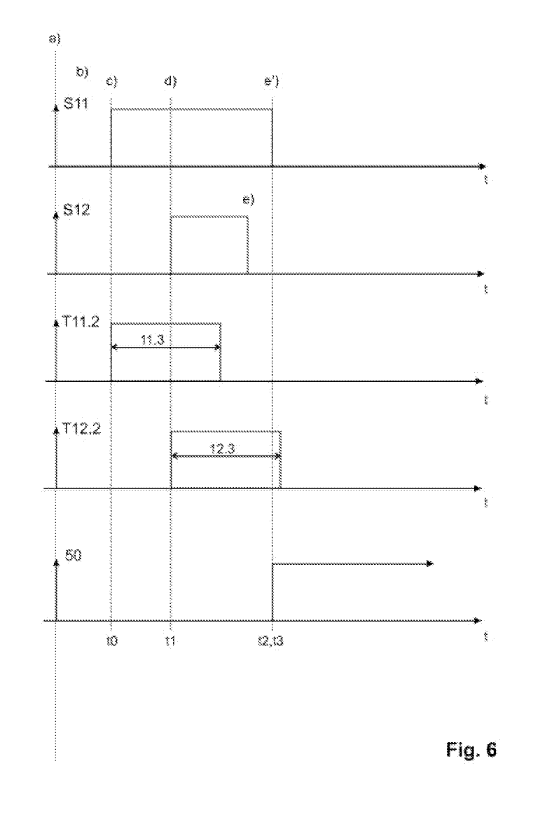

FIG. 5 shows a schematic view of the functional connection between the control device 20 and the first sensor 11 and second sensor 12. The control device 20 has a logical device 22 which is indicated as an AND logical element. In the further FIGS. 6 to 10, the method according to the invention is illustrated and explained in greater detail.

FIG. 6 shows a chronological flow diagram for the method according to the invention. In this method, only the two sensors 11, 12 are used, and each start then timer 11.2 or 12.2 upon their activation if the corresponding movement pattern is executed correctly. As can be seen, both sensors 11 and 12 are initially deactivated. Next, the sensor 11 detects an object 17 at time point t0, and is activated as a result. The first timer 11.2 is started as a result of the activation of the sensor 11, and runs for a predefined time span 11.3. In this time span 11.3, the second sensor 12 detects the object 17 at time point t1, whereby the second timer 12.2 likewise is started for a predefined time span 12.3. According to the variant of the method according to the invention, the actuation of the virtual switch can occur according to step e) if the second sensor 12 is deactivated during the time span 12.3 of the second timer 12.2. The individual method steps a) to e) and/or e′) are inserted into the chronological flow diagram for the purpose of clarification. In the present case in FIG. 6, however, the first sensor 11 must also additionally be deactivated (see step e′)), and particularly during the time span 12.3 of the second timer 12.2 so that the virtual switch 50 is actuated and generates an actuation signal for the moving part 10.

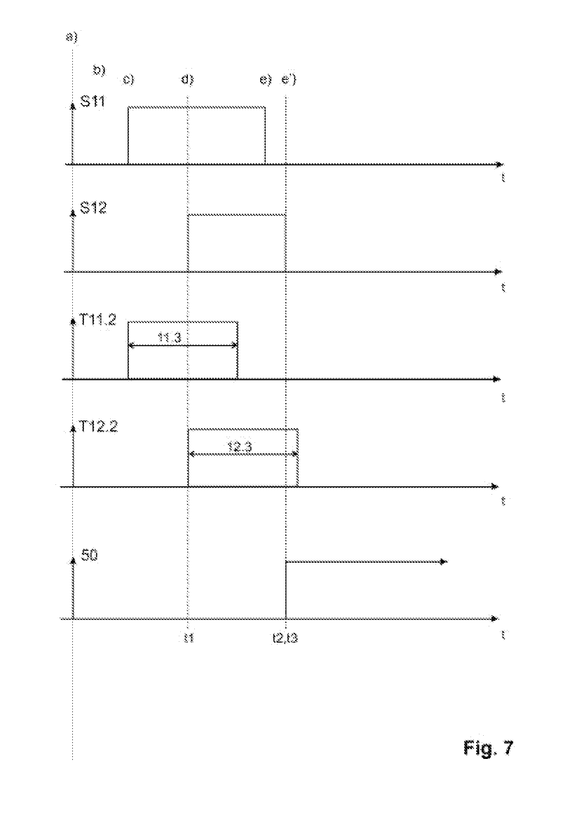

A further variant for the flow of the method according to the invention is illustrated in FIG. 7. In contrast to the variant in FIG. 6, in this case the first sensor 11 is first deactivated and then the second sensor 12 is deactivated. The virtual switch 50 is actuated at time point t2 and/or t3 if the second sensor 12 is deactivated during the time span 12.3.

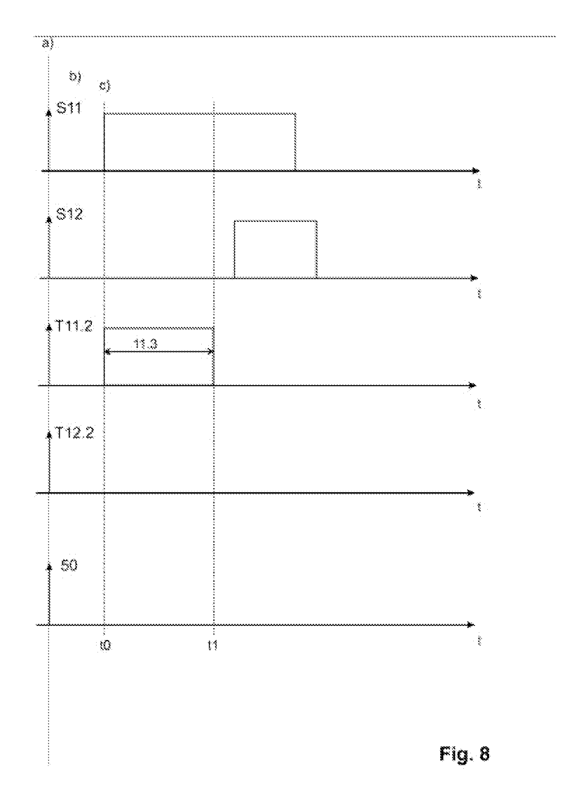

A first instance of a false movement pattern for the actuation of the virtual switch 50 is illustrated in FIG. 8. In this case, the method according to the invention starts completely normally with step a), then the first sensor 11 is monitored in step b) and is activated at time point t0. In this way, the first of the timers 11.2 is started for its predefined time span 11.3 (see step c)). In any case, neither the first sensor 11 nor the second sensor 12 is activated during the time span 11.3. As such, the time span 11.3 for the timer 11.2 runs out without being utilized, because no further movement is recognized in this time span 11.3 by the sensors 11, 12. As a result, the steps d) and consequently e) are not initiated. The present method is only started again if both of the sensors 11 and 12 are deactivated.

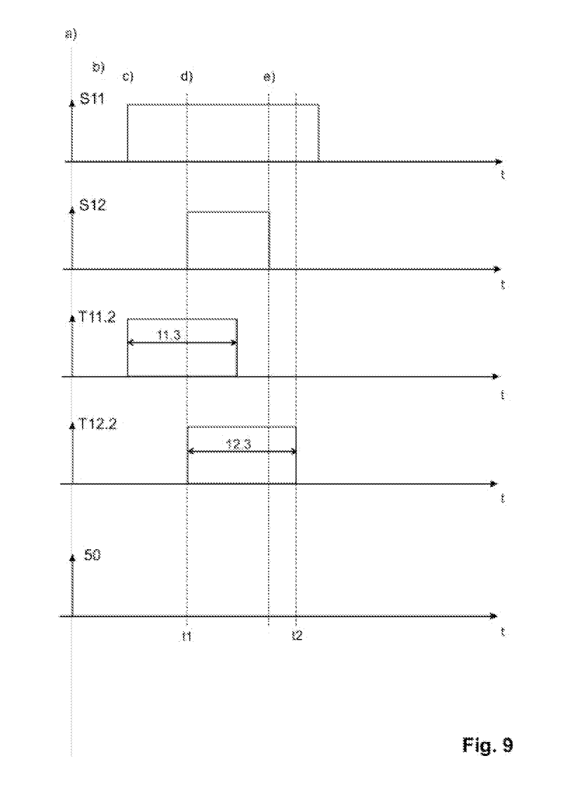

FIG. 9 illustrates a second case of a false movement pattern for actuating the virtual switch 50. In this case, the method according to the invention starts entirely normally with step a), and then in step b) the first sensor 11 is monitored and is activated at time point t0. In this way, the first of the timers 11.2 is started for its predefined time span 11.3 (see step c)). In this time span 11.3, the second sensor 12 is activated and the timer 12.3 is started, see step c). As in FIG. 6, the second sensor 12 is then still deactivated, and particularly within the time span 12.3. However, the first sensor 11 is additionally not deactivated in the time span 12.3, but rather only later (see step e) only). In this way, the virtual switch 50 does not supply an actuating signal, because the prerequisites for step e′) are not met. The present method is only started again when both of the sensors 11 and 12 are deactivated.

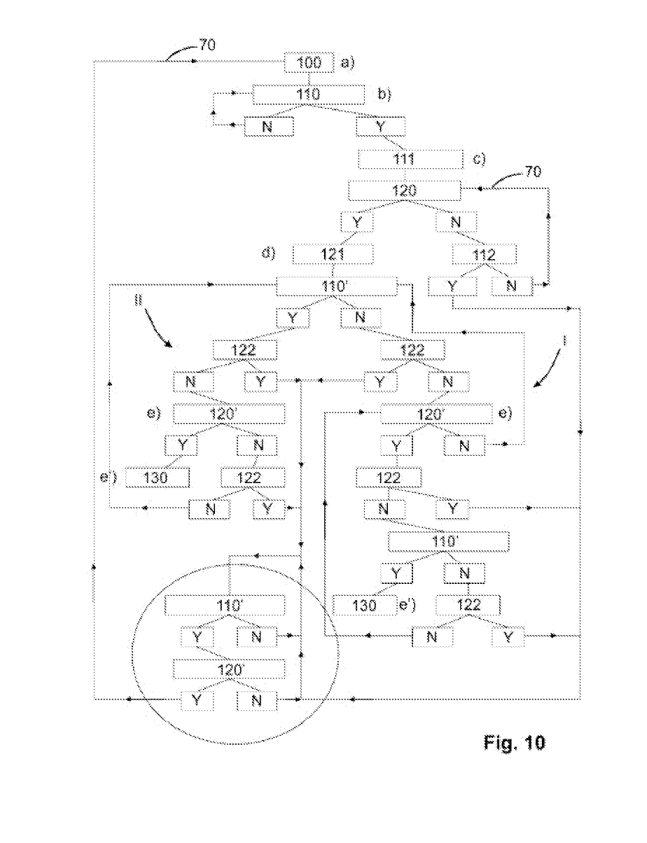

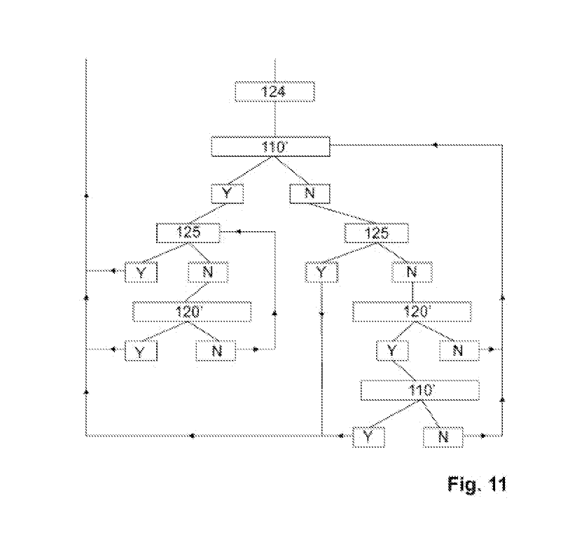

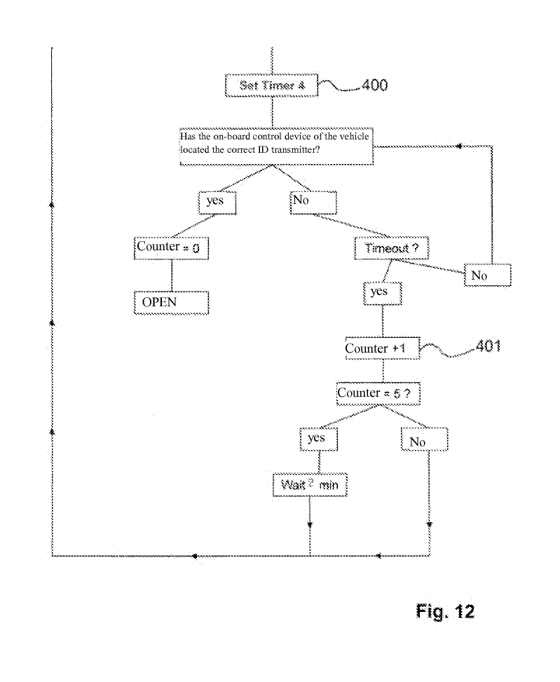

The flow diagram for the method according to the invention is illustrated in FIG. 10, wherein both variants are present for the recognition of the concrete movement pattern for the actuation of the virtual switch 50 according to step e′). In the first variant I, the second sensor 12 must initially be deactivated. This deactivation must take place within the time span 12.3 of the second timer 12.2 (see FIG. 6 also). In this case, the path I on the right of the flow diagram is shown with step e). In the second variant II in the path II on the left of the diagram in FIG. 10, the first sensor 11 must be initially deactivated (see step e)), followed by the second sensor 12 (see step e′)). The deactivation of the second sensor 12 must take place within the time span 12.3 of the second timer 12.2 in order to actuate the virtual switch 50. This left path II in step e) in the flow diagram 10 corresponds to the process flow in FIG. 7.

As can be clearly seen in FIG. 10, the method is completed in the present case when the second timer 12.2 runs out and one sensor 11 and/or 12 is still activated. In this case, it is then immediately checked first whether the sensor 11 is deactivated and then whether the sensor 12 is deactivated. Only when both of the sensors 11 and 12 are deactivated is the method started again at step a) (see reference number 100). In reference number 110, the sensor 11 is queried for activation. In reference number 111, the first timer 11.2 is started. In reference number 110′, the sensor 11 is queried for a deactivation. Reference number 112 indicates a query of the first timer 11.2 as to whether the time span 11.3 has run out. The query as to whether the second sensor 12 is activated is indicated by the reference number 120. The deactivation of the second sensor 12 is queried at reference number 120′. The second timer 12.2 is started at reference number 121. The time profile of the second timer 12.2 is queried at reference number 122. At reference number 130, the actuation of the virtual switch 50 takes place.

A preferred embodiment of the invention is described in FIG. 12, wherein the functionality of the timer (400) is disclosed below. Before the trunk hatch is intended to be opened, a query takes place, the same being carried out by a timer (400). The timer (400) checks whether the on-board control device of the vehicle has found the correct ID transmitter. If the on-board control device had not found the correct ID transmitter, then a check is made over a prespecified period of time (for example 5 seconds) of whether no ID transmitter is in fact to be found in the surroundings of the hatch intended to be opened. If no ID transmitter has been found upon the completion of the prespecified period of time, then a counter memory (401) is set to the value 1. The set value is compared to a prespecified fixed value—which in the present embodiment is the value 5, wherein 5 is the highest digit of the loop—and if the set value is smaller than the prespecified value, the method is restarted at step a) (see reference number 100). If the set value is equal to the prespecified value, then the method is stopped for a prespecified period of time (in the present embodiment, 2 minutes). Upon the completion of the present period of time, the method is restarted at step a) (see reference number 100).

If the on-board control device of the vehicle has found the correct ID transmitter, then the counter memory is set to zero and the actuation of the virtual switch (50) occurs.

The timer (400) advantageously reduces an undesired, repeating, and external environment-based maloperation.

Instead of a counter, the sensitivity of the field, the detection area, or the detection threshold can be modified.

The method according to the invention is only restarted at step a) if a deactivation of the two sensors 11, 12 has occurred (see the circle below left in FIG. 10).

FIG. 11 illustrates the method according to the invention from the circle at the lower left in FIG. 10. In this case, an additional timer is started for a predefined time span (124). Next, the first sensor (110′) is queried for deactivation. Upon a yes (Y) and also upon a no (N), in both cases a further query is made for whether the additional timer has run out (125). If the additional timer has run out, the method restarts at step a). As can be seen in the two branches at left and right under the timer query (125), on the left only the deactivation of the second sensor (120′) is queried, and in the right branch an additional query is made once more, following the first query, of the deactivation of the first sensor (110′), because the query for this right branch has been previously returned as negative. Next, the method restarts at step a).

Finally, it is hereby noted that additional variants of the method and the device according to the invention can be contemplated. As such, the duration of the time spans 11.3 and 12.3 can vary in length, for example. In addition, at least one further sensor can be included, wherein the activation and/or deactivation thereof is likewise monitored, and wherein said further sensor optionally starts a further timer. In addition, the chronological sequence of queries of the illustrated sensors 11, 12 and their spatial position can vary.

1. A method for the actuation of a virtual switch, having a sensor system which detects an actuation of the switch, wherein the sensor system has at least two touchless sensors,
wherein
the following steps are executed:
a) initiation of the method
b) monitoring of at least one first sensor
c) starting of a first timer for a first time span if the first sensor is activated (by means of an approaching object)
d) initiation of a second timer for a second time span if the second sensor is activated (by an approaching object) and the first time span is not yet exceeded
e) actuation of the virtual switch if at least one sensor is deactivated and the second time span is not yet exceeded,
and wherein particularly the steps a) to e) are carried out partially at the same time or in a chronological sequence one after the other.

2. A method according to the preamble of claim 1 or according to claim 1,
wherein
the method is only restarted once all sensors are first deactivated, wherein the first sensors and/or then the second sensor is/are deactivated and/or vice-versa.

3. A method according to claim 1,
wherein
the first sensor and/or the second sensor is first deactivated after step d).

4. A method according to claim 1,
wherein
the following steps are executed:
e′) actuation of the virtual switch if at least two sensors are deactivated and the second time span is not yet exceeded.

5. A method according to claim 1,
wherein
the first time span and/or the second time span is fixed and prespecified, wherein particularly the time span is between 10 ms and 2 s.

6. A method according to claim 1,
wherein
upon a successful actuation of the virtual switch, a moving part comprising a door, hatch or the like in a vehicle is opened.

7. A method according to claim 1,
wherein
no later than after step b), an authentication query is started with a mobile ID transmitter in order to unlock an access control or security system, particularly in a vehicle.

8. A method according to claim 1,
wherein
a calibration process is executed before the first initiation of the method, in order to calibrate the sensor system with the sensors.

9. A method according to claim 4,
wherein
a prespecified movement pattern is required for the actuation of the virtual switch, wherein the movement pattern is saved in the method by the sequence of the deactivation of the sensors following step e) and/or e′) and the time spans for the timers.

10. A method according to claim 1,
wherein
the method only starts if the vehicle is at a speed lower than 3 km/h and/or all sensors are first deactivated.

11. A device for the actuation of a virtual switch, having a sensor system which detects an actuation of the virtual switch, wherein the sensor system has at least two touchless sensors and a control device which has at least one first timer and a storage device for a first time span, and the control device monitors, by means of measurement, the sensors, wherein a method according to claim 1 for the operation of the device is stored in the control device.
